(19) United States
(12) Patent Application Publication
(10) Pub. No.: US 2026/0295798 A1
(43) Pub. Date: Oct. 1, 2026

(54) GROOMING MULTI-TOOL

(71) Applicant: ZACHARY HARDIN, SOUTH LYON, MI (US)

(72) Inventor: ZACHARY HARDIN, SOUTH LYON, MI (US)

(21) Appl. No.: 19/306,933

(22) Filed: Aug. 21, 2025

Related U.S. Application Data
(60) Provisional application No. 63/777,408, filed on Mar. 25, 2025.

(51) Int. Cl. B25F 1/00; A45D 29/02; A45D 29/04

(52) U.S. Cl. CPC B25F 1/003; A45D 29/02; A45D 29/04

(57) ABSTRACT

A compact hand-held multi-tool includes a housing supporting an axle that carries multiple tools pivotable between stored and use positions. A locking mechanism selectively retains tools in the stored and/or use positions, and a user-operable release can bias a selected tool outward for grasping. In some embodiments, paired housings are hinged to actuate tweezers or scissors by relative housing movement. The housing may define an accessory bay receiving a removable accessory module that electrically couples to internal circuitry via a connector; the module may carry an LED, a memory device, charge-management circuitry, a rechargeable cell, and a charging interface. A port can operatively couple an external electronic accessory. The tool set can include grooming implements (e.g., clippers, a file, scissors, tweezers, a toothpick) and miniature hand tools (e.g., a screwdriver, a bottle opener). Variants support user reconfiguration, sealed constructions, and compact carry.

### CROSS-REFERENCE TO RELATED APPLICATIONS

This application claims the benefit of and priority under 35 U.S.C. § 119(e) to U.S. Provisional Patent Application No. 63/777,408, filed Mar. 25, 2025, the entire contents of which are incorporated by reference herein.

### BACKGROUND OF THE INVENTION

In today's busy world, personal grooming often is neglected. As people have increasingly busy schedules, they often feel rushed and personal grooming is a common casualty. In the past, people may have carried a grooming device, such as a comb or brush. However, those items are bulky and inconvenient to carry every day.

Many people often encounter situations when they are away from home, where their grooming typically occurs. As a result, they may notice that their finger nails need to be trimmed when on the go, or they develop a hangnail and need a nail file, or they need a pick, tweezers, or a small screwdriver to repair their glasses. Ordinarily, people would have to carry separate items for each of these tasks, which is inconvenient at the least and not possible at the worst. Additionally, many of these separate items are small and easily lost, requiring their replacement. Often, the item that is lost is the item that is most urgently needed.

What is needed then is a small grooming multi-tool that offers multiple grooming devices in a single, pocket-sized package for maximum portability. The grooming multi-tool of the present invention may be placed in a pocket, purse, handbag, briefcase, sports bag, or luggage, for example. The grooming multi-tool of the present invention solves these problems by combining many small grooming items and tools in a single device, which is easier to handle and less likely to be misplaced.

### SUMMARY OF THE INVENTION

The grooming multi-tool of the present invention is a hand-held device that includes a plurality of personal grooming items and assorted tools to assist a user in personal grooming and is a handy tool for unexpected problems.

The grooming multi-tool may include a plurality of bathroom grooming tools, such as nail clippers, a nail file, a toothpick, scissors, and tweezers. Additionally, the grooming multi-tool may include a plurality of miniature hand tools, such as a standard or cross-headed screwdriver, and a bottle opener, for example.

The grooming multi-tool of the present invention may be configured with an outer housing that may be of a variety of shapes, such as but not limited to a generally rectangular box with rounded ends, such that the housing easily fits in the palm of a user's hand. The housing may be in a plurality of sizes, which may be dependent upon the number of tools contained within. The housing includes at least one axle/pin at an end of the housing, through which a plurality of tools may be rotatably connected and retained within the housing.

The grooming multi-tool of the present invention may also be configured as a pair of housings that may be pinned together at one end, but the opposite end may not be not pinned, so that the pair of housings may be stored adjacent to each other but may also be unfolded, allowing the tools stored within to be accessed and providing the user with additional leverage and tool handling surface as the pair of housings may be folded back adjacent to each other.

The various tools of the grooming multi-tool are typically stored within the housing, as their configuration allows the tools to nest when stored within, yet allowing a user to selectively remove only the desired tool. The various tools of the groomer multi-tool may include hand or nail extensions to allow for a user to withdraw the tool from the housing. Additionally, the grooming multi-tool may include devices to lock and/or unlock each tool when it is stored or retracted from the housing, respectively.

In one aspect, a portable grooming multi-tool includes a hand-sized housing supporting an axle that carries a plurality of tools pivotable between stored and use positions. A locking mechanism is configured to releasably retain at least one of the tools in the stored and/or use positions. The plurality of tools includes at least one grooming implement (for example, nail clippers, a nail file, scissors, tweezers, or a toothpick) and at least one miniature hand tool (for example, a screwdriver or a bottle opener). In some embodiments, the housing comprises first and second housing portions arranged along a dominant length with opposing open sides sized to receive the tools when stored. In certain implementations, at least one tool provides a fingernail catch to facilitate extraction. The locking mechanism may include a spring-biased detent associated with the axle, and a user-operable release such as, but not limited to, a push-button, may bias a selected tool outward to present it for grasping. The housing can include a grip-enhancing surface treatment, such as leather or a leather substitute with stitching. In optional embodiments, the multi-tool further includes an electronic accessory such as an LED light, a USB memory device, or a portable charger. In reconfigurable versions, a user can remove an undesired tool from the axle and install a different tool, and the housing capacity can be expanded or contracted by altering an axle configuration.

In another aspect, a grooming multi-tool includes a pair of housings pinned together at a first end to define a hinge. A pair of tweezers is disposed between the housings and is actuated by relative movement of the housings so that opening and closing the housings respectively opens and closes opposed tweezer jaws. A plurality of additional tools is pivotally coupled to an axle carried by at least one of the housings and nests within the housings when closed. In certain embodiments, the tweezers are lockable in a deployed position via the axle or the hinge pin. Unfolding the housings can provide increased leverage and an enlarged tool-handling surface for a deployed tool. The tool actuated by relative housing movement can alternatively be scissors or pliers. At least one housing may include a window configured to display user identification, and the housings may be formed in a novelty or ergonomic shape, such as an ovoid or a flattened football profile.

In yet another aspect, a method of using a portable grooming multi-tool having a housing, an axle supported by the housing, and a plurality of tools pivotally coupled to the axle includes actuating a release to overcome a lock retaining a selected tool in a stored position within the housing; rotating the selected tool to a use position; performing a task selected from a grooming operation or a miniature repair operation; and returning the selected tool to the stored position. In some implementations, actuating the release includes pressing a spring-loaded button that at least partially presents the selected tool for grasping. In embodiments with two housings pinned at one end, the selected tool can be a pair of tweezers actuated by relative housing movement. The method can further include swapping the tool set by removing an undesired tool from the axle and installing a different tool, energizing an electronic accessory (such as an LED light, a USB memory device, or a portable charger) during the task, and selecting a surface texture of the housing to improve user grip.

Any of the foregoing features and options can be used alone or in combination, unless clearly incompatible, to achieve compact carry, reliable deployment, ergonomic handling, user customization of the tool set, and optional integration of electronic accessories.

### BRIEF DESCRIPTION OF DRAWINGS

The disclosure is described in greater detail by way of the example only and with referenced to the attached drawings, in which:

FIG. 1 is a top view of the grooming multi-tool, according to embodiments of the disclosure;

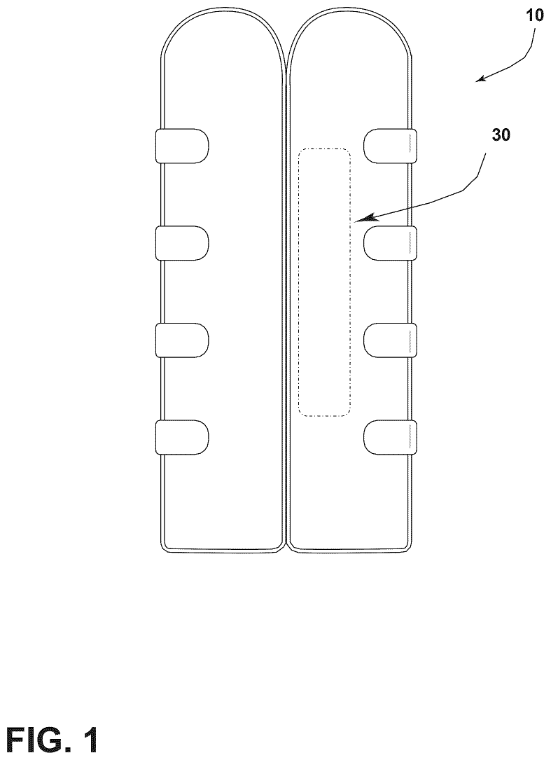

FIG. 2 is a top view of the grooming multi-tool of FIG. 1, with the grooming multi-tool shown in a partially open position, according to embodiments of the disclosure;

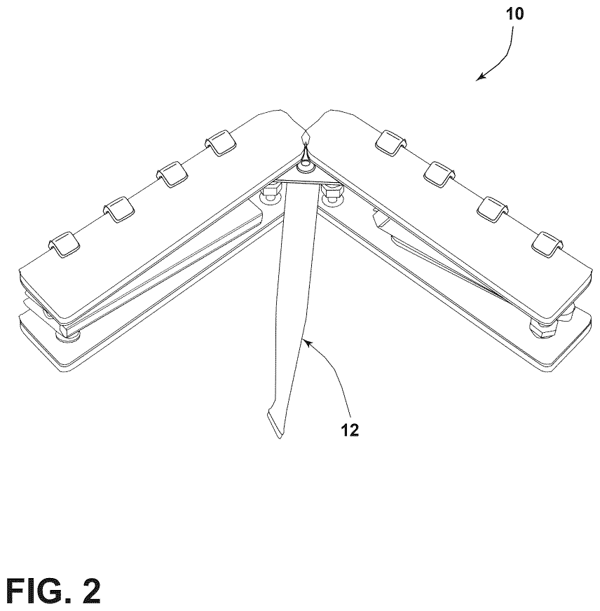

FIG. 3 is another top view of the grooming multi-tool of FIG. 1, with the grooming multi-tool shown in a partially open position, according to embodiments of the disclosure;

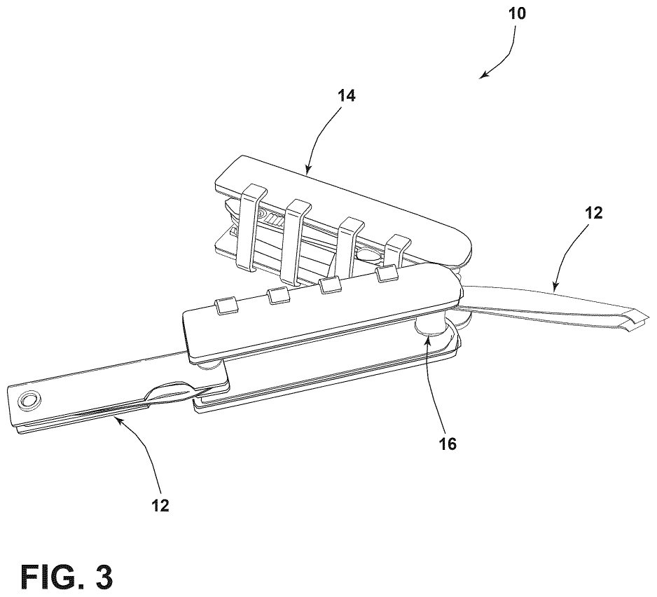

FIG. 4 is another top view of the grooming multi-tool of FIG. 1, with the grooming multi-tool shown in a partially open position, according to embodiments of the disclosure;

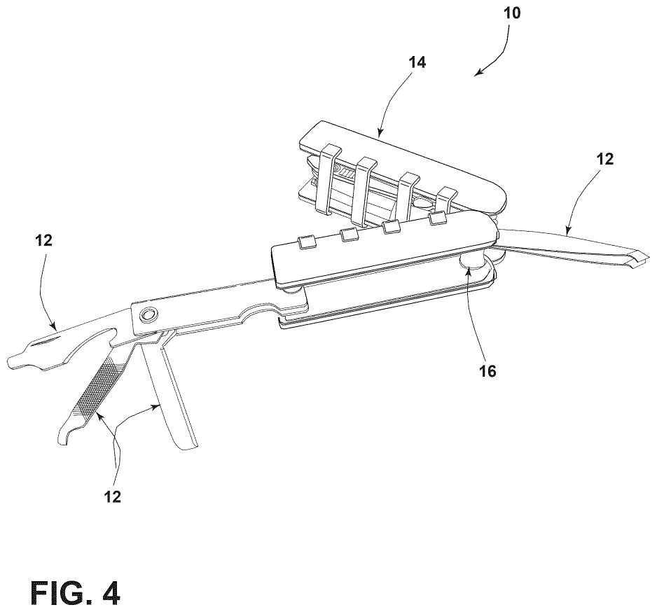

FIG. 5 is another top view of the grooming multi-tool of FIG. 1, with the grooming multi-tool shown in a partially open position, according to embodiments of the disclosure;

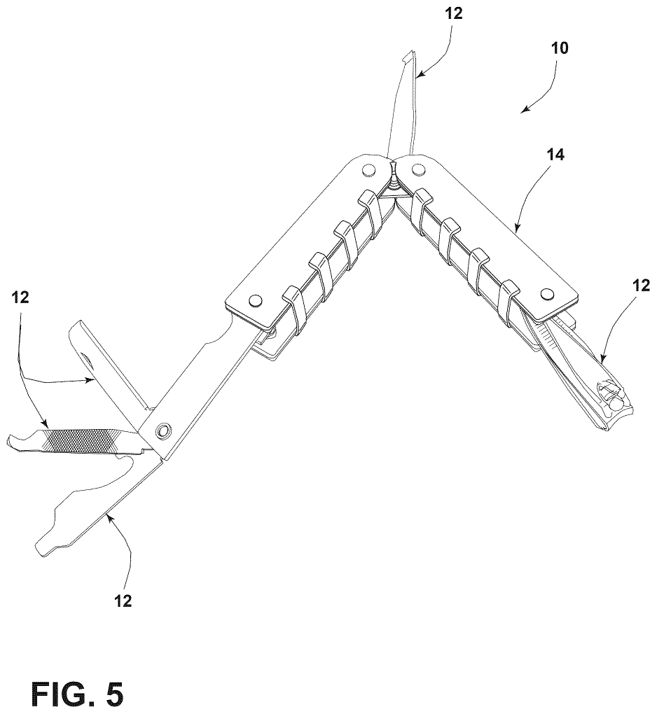

FIG. 6 is another top view of the grooming multi-tool of FIG. 1, with the grooming multi-tool shown in a partially open position, according to embodiments of the disclosure;

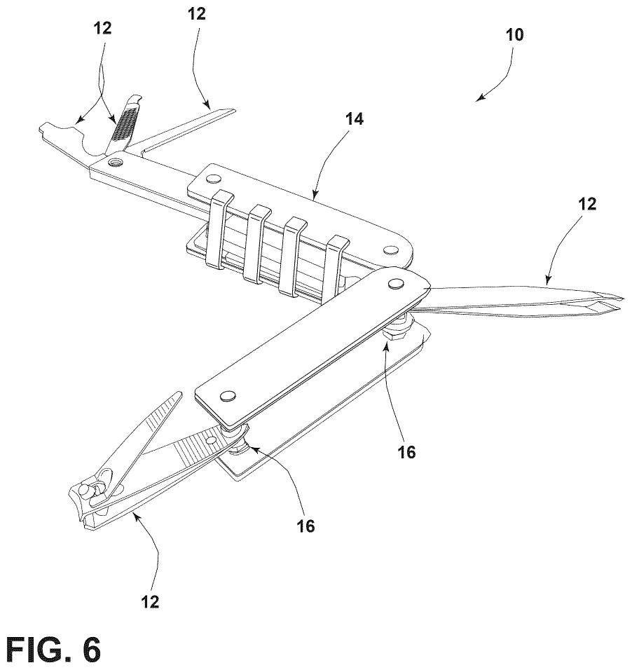

FIG. 7 is another top view of the grooming multi-tool of FIG. 1, with the grooming multi-tool shown in a partially open position, according to embodiments of the disclosure;

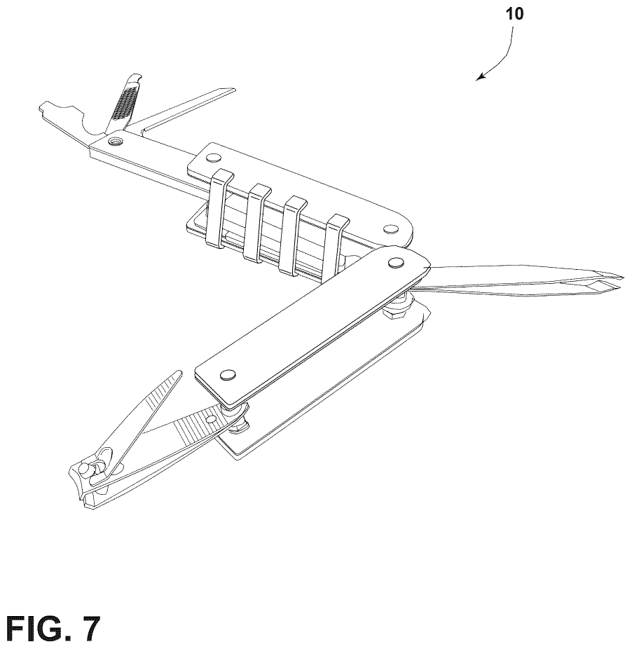

FIG. 8 is another top view of the grooming multi-tool of FIG. 1, with the grooming multi-tool shown in a partially open position, according to embodiments of the disclosure;

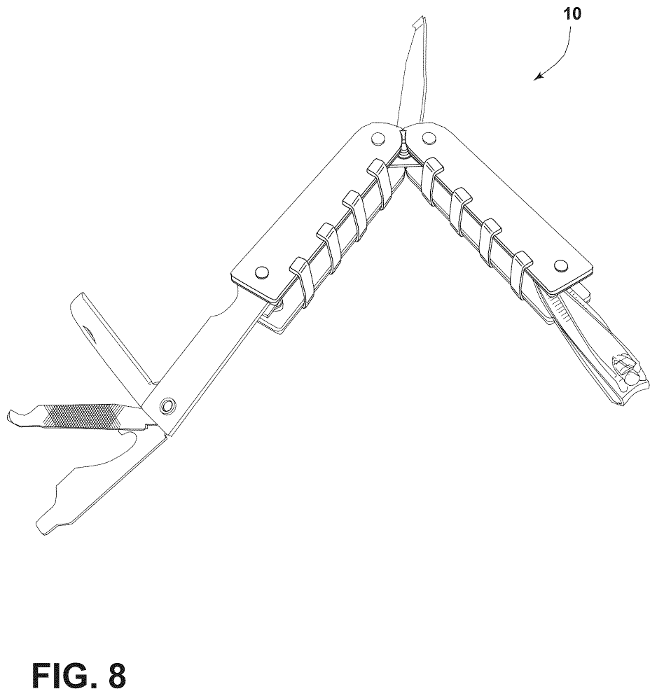

FIG. 9 is another top view of the grooming multi-tool of FIG. 1, with the grooming multi-tool shown in a partially open position, according to embodiments of the disclosure;

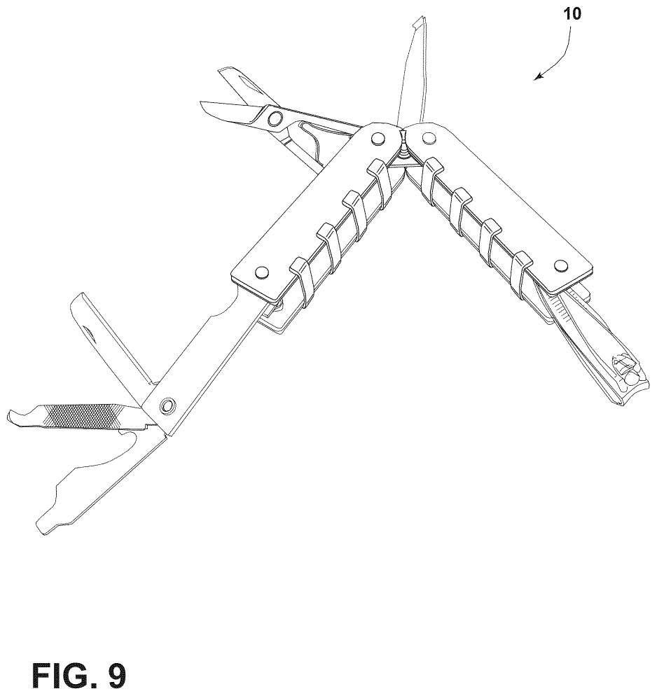

FIG. 10 is another top view of the grooming multi-tool of FIG. 1, with the grooming multi-tool shown in a partially open position, according to embodiments of the disclosure;

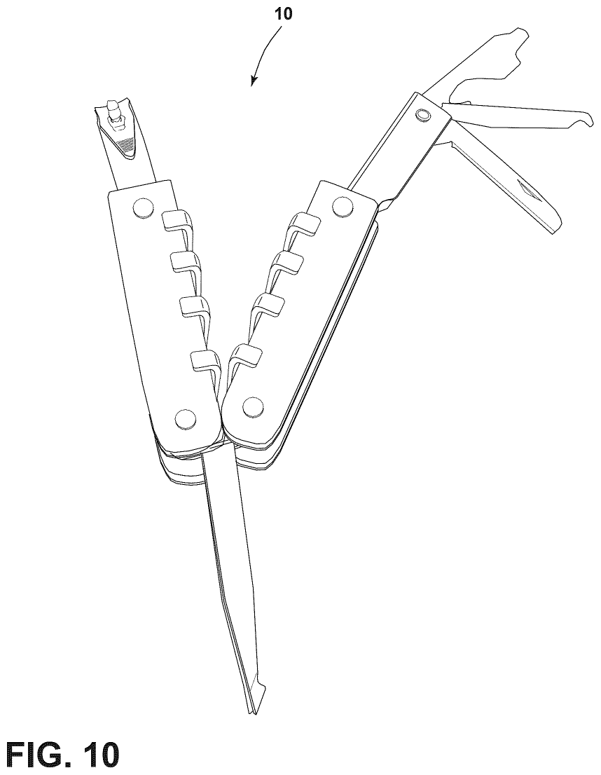

FIG. 11 is another top view of the grooming multi-tool of FIG. 1, with the grooming multi-tool shown in a partially open position, according to embodiments of the disclosure; and

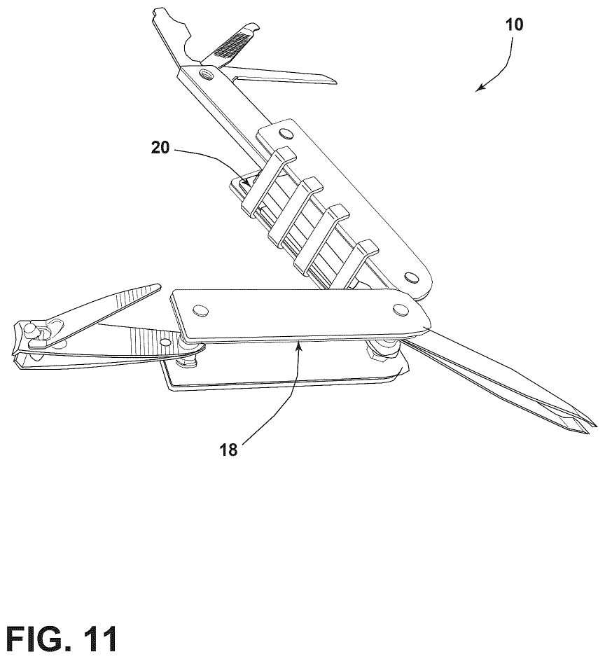

FIG. 12 is another top view of the grooming multi-tool of FIG. 1, with the grooming multi-tool shown in a partially open position, according to embodiments of the disclosure.

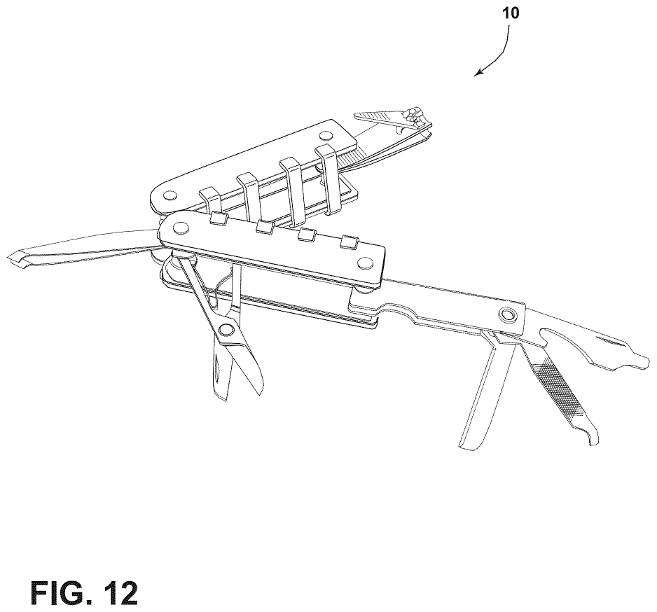

For clarity of illustration, not every component described in the Detailed Description is shown in every figure. Certain optional or non-essential elements (e.g., electronic accessories, fasteners, seals, wiring, and control circuitry) may be omitted, simplified, or depicted schematically without limiting the scope of the disclosure. Where the text refers to features “not shown” or “omitted for clarity,” such features are nevertheless contemplated unless expressly excluded.

### DETAILED DESCRIPTION OF THE INVENTION

The following detailed description is directed to illustrative embodiments of devices, systems, and methods for a portable grooming multi-tool. The scope of the claims is not limited to the embodiments described herein. The embodiments are provided to enable any person skilled in the art to make and use the claimed subject matter.

The drawings depict non-limiting examples for ease of explanation. The drawings are not necessarily to scale, and relative dimensions may be exaggerated for clarity. In the figures and description, like reference numerals refer to like elements throughout. Positional and directional terms such as “upper,” “lower,” “front,” “rear,” “left,” “right,” “inner,” and “outer” are used for convenience with reference to the drawings and do not require a particular orientation unless explicitly stated. Components may be shown in simplified form; features not necessary for understanding may be omitted.

As used herein, the singular forms “a,” “an,” and “the” include plural referents unless the context clearly dictates otherwise. The terms “include,” “includes,” “including,” “have,” and “having” are intended to be open-ended and mean “including, but not limited to.” The term “or” is intended to be inclusive, meaning “and/or,” unless the context clearly indicates otherwise. The phrase “based on” means “based at least in part on.”

The term “configured to” describes structural features and/or arrangements that enable the recited capability; it does not require or imply any particular mode of operation at all times. “Coupled” or “operatively coupled” means directly or indirectly joined so as to permit cooperation or interaction (mechanical, electrical, or magnetic). “Connected” generally denotes a direct physical connection unless stated otherwise. “Optional” means that the subsequently described feature may or may not be present.

Numerical values may be exact or approximate. Unless indicated otherwise, “about” or “approximately” may refer to ±10% of the stated value, or ±5% where context suggests tighter tolerances. Ranges recited herein include all sub-ranges and individual endpoints. Lists presented with “for example,” “such as,” or similar language are non-exhaustive.

Method steps may be performed in any suitable order unless a particular order is expressly required or inherently dictated by context. The use of “first,” “second,” and similar labels is solely for distinguishing elements or steps and does not by itself imply order, priority, or quantity.

No element or limitation in this disclosure is intended to be construed under 35 U.S.C. § 112(f) (pre-AIA § 112, ¶6) unless the claim language expressly uses the phrase “means for” or “step for.” Absent such express recitation, functional descriptions are understood to be recitations of structural features, materials, or acts.

To the extent permitted, any references cited are incorporated by reference in their entireties for all purposes consistent with this disclosure; however, essential subject matter is provided herein, and the claims are supported without reliance on incorporation by reference.

In representative embodiments, a multi-tool 10 includes a housing 14 supporting an axle or pin 16 that carries tools 12 pivotable between stored and use positions. One or more locking mechanisms selectively retain tools in the stored and/or use positions, and a user-operable release may at least partially present a selected tool for grasping. Certain embodiments employ paired housings that hinge at one end to actuate tweezers or scissors via relative housing movement. Exterior surfaces 18, which may include decorative or grip-enhancing features such as stitching 20, can be varied without departing from the spirit and scope of the disclosure. Features described in connection with any embodiment may be combined with features of any other embodiment unless clearly incompatible.

The embodiments described herein may include optional features that are not expressly labeled or depicted in the drawings. By way of non-limiting example, one or more electronic accessories may be provided, including an LED assembly, a memory device (e.g., flash/USB), charge-management circuitry, a rechargeable or primary cell, a charging interface (e.g., USB-C, micro-USB, magnetic, or wireless inductive), and associated wiring or interconnects. Any such accessory may be disposed within, partially within, or on the housing (e.g., embedded beneath a cover, flush-mounted to a surface, or carried in a removable cartridge/bay), or coupled externally via a connector or port. Omission of a particular accessory from a given figure is for clarity only and does not indicate inapplicability to that embodiment.

Unless stated otherwise, references to a component being “within” the housing encompass fully internal placement, partially recessed or flush placement, or mounting behind a removable panel; references to a component being “coupled to” the housing encompass direct and indirect connections, including but not limited to, fasteners, adhesives, snap-fits, magnetic couplers, flex circuits, and electrical connectors.

In some embodiments (not shown), the housing includes a universal accessory bay configured to receive interchangeable modules carrying any combination of the foregoing electronic accessories. Modules may be factory-installed or user-replaceable and may be retained by fasteners, detents, latches, magnetic capture, or interference fit. In other embodiments (schematically represented or omitted for clarity), the accessories are integrated into existing structures (e.g., an LED in an end cap; memory in a side panel; a battery along an interior rib), share components (e.g., a common power switch), or are remote but operatively coupled (e.g., a key-chain light or charger tethered through a port).

The functional descriptions of accessories are intended to embrace structural implementations readily apparent to skilled artisans. For example, an LED assembly may include a package, lens or light pipe, driver, switch, and power source; a memory device may include a controller and socketed or soldered media; and charge-management may include protection, regulation, and indicators. Variants using equivalent parts and layouts are contemplated.

Features described in connection with any embodiment may be combined with any other embodiment unless clearly incompatible. The drawings are not to scale, and the relative size, shape, and position of non-illustrated features should be understood from the text.

As embodied and broadly described here and in the Drawings, the present disclosure is directed to a grooming multi-tool 10 for personal grooming and providing the user with grooming/hand tools 12 for making repairs and other uses.

The grooming multi-tool 10 of the present invention may be configured with housing(s) 14 of various shapes and sizes, including but not limited to one or a pair of rounded rectangular boxes with open sides across the dominant length. The pair of opposing sides, the non-dominant length sides, may include one or more axles or support pins 16 which provide strength and rigidity to the grooming multi-tool 10. In addition, the axles or pins 16 may be configured to receive one or more grooming and/or hand tools 12.

It should be understood that the housing 14 of the present invention may be configured as a single element or multiple elements (e.g., two or more) and that the disclosure herein is merely exemplary and not limiting.

The housing 14 may also be configured in other shapes and sizes, with a consideration given to the housing 14 being easy to hold in a user's hand (e.g., ergonomic). For example, the housing 14 may be configured in a single or pair of oval or ovoid shapes. In addition, it is contemplated that the housing 14 may be configured in other shapes and sizes, including novelty shapes of various items. For example, the housing(s) 14 may be configured in the shape of a flattened football, and may include football team logos. It is further contemplated that the housing(s) 14 of the grooming multi-tool 10 may be configured in other shapes such as promotional items—a vehicle, a fish, or other geometric or random shape, or one taken from another source.

The housing(s) 14 may also include other useful tools/devices 12, such as but not limited to, a USB memory stick, a light (e.g., an LED light), a portable charger for mobile devices, a writing instrument (e.g., pencil, pen, or marker), a measuring device (e.g., a ruler, tape measure), a laser pointer, among other devices in a optional accessory module 30. The housing 14 may also be configured to receive printed text or include a window that may display the user's name or other identifying information (not shown).

The axles or pins 16 of the grooming multi-tool 10, while providing strength and rigidity to the housing(s) 14, also secure a plurality of grooming and/or hand tools 12 to the housing 14. The axles or pins 16 allow the grooming/hand tools 12 to be selectively withdrawn from within the housing 16, which may follow an arc about the axle/pin 16. It is contemplated that other configurations of storing grooming/hand tools 12 in the housing 16 are possible, and the present disclosure is only exemplary and not limiting. The axles/pins 16 may be configured to lock the grooming/hand tools 12 within the housing 14 when the tools 12 are not deployed by the user. Locking the tools 12 within the housing 14 may prevent the tools from extending beyond the housing 14, which may could otherwise cause a tool 12 to catch on an object or otherwise cause damage to the grooming multi-tool 10 or the user.

The user may overcome the locking mechanism of the axles/pins 16 of the grooming multi-tool 10 by grasping a portion of the grooming/hand tools 12 and pulling or otherwise separating the tools 12 from the housing 14. The tools 12 may include portions that easily allow the user to grasp the selected tool 12, such as a fingernail catch, but other mechanisms are contemplated, such as a release button. In the embodiment including the release button, a spring-loaded mechanism integrated with or in addition to the axles/pins 16 may be configured to, upon the pressing of a particular button or other device, allow the selected or configured tool 12 to extend outside the housing 14, whereby the user may more easily grasp the tool 12 for use or to more fully extract the tool 12 from the housing 14.

In embodiments, the grooming multi-tool 10 may include a tool 12 such as a pair of tweezers. The pair of tweezers (“tweezers”) may be configured to function with the movement of one or more housing elements 14, or “arms”. In the embodiment having a pair of housings 14, the rotation of the pair of housings 14 apart from the stored position to the extended position may reveal a tool 12 such as tweezers, or other tools 12 such as pliers or scissors. Upon full rotation of the pair of housings 14, in this embodiment, the tweezers or other tool 12 may be locked in position via the axles/pins 16 and movement of the pair of housings 14 may allow the user to open and close the tweezers, pliers, or other similarly-operated tool 12.

In embodiments, the grooming multi-tool 10 may include additional tools 12 stored within one or more housing elements 14. These tools 12 may include a nail file, a toothpick, one or more screwdrivers, a bottle opener, or other devices as described herein. It is also contemplated that additional devices/tool 12 may be included that are appropriate for the grooming multi-tool 10.

In embodiments, the grooming multi-tool 10 may be configured such that the type and number of tools 12 contained within may be changed by the user. For example, the user may desire to configure the grooming multi-tool 10 for a vacation or business trip. The user may selectively remove undesired tools 12 and install desired tools 12 to “configure” the grooming multi-tool 10 for such a trip. If the user is going camping, the user may reconfigure the grooming multi-tool 10 for a camping trip, by replacing some tools 12 and installing other tools 12, such as a saw.

In embodiments, the grooming multi-tool 10 may be configured to be expandable (e.g., the housing 14 may be configured to allow for more tools 12 to be installed). By changing the configuration of axle/pin 16, the grooming multi-tool 10 may be expanded, or alternatively, contracted, as the user desires. For example, if the user desires to carry the grooming multi-tool 10 in a clothing pocket and finds that the grooming multi-tool 10 is too large, the user may choose to remove tools 12 and/or axles/pins 16 to contract the grooming multi-tool 10, or make it smaller and more portable.

The surface 18 of the housing 14 may be configured in a plurality of ways. In one embodiment, the surface 18 may be configured as a football, with an outer covering that may be leather or a leather substitute and may include other elements such as stitching 20 to further add to the football motif. The surface 18 and/or stitching 20 may also provide additional ergonomic features, allowing the grooming multi-tool 10 to be more easily gripped by a user. In other embodiments, the surface 18 may be configured in a plurality of ways as described herein, which may include other geometric shapes, or be patterned after, or stylized after, other objects, including vehicles, sports gear, animals, etc.

In certain embodiments, the locking mechanism includes a spring-biased detent or back-spring acting on a tang of each tool such that the tool “snaps” into the stored and/or use positions. In other embodiments, a liner-lock, frame-lock, or cammed latch engages a shoulder of the tool in the use position. A user-operable release, e.g., a push-button, slider, or rocker coupled to or integrated with axle/pin 16, temporarily disengages the lock and may bias a selected tool outward (e.g., 1-5 mm) to facilitate grasping by a fingernail catch.

In certain embodiments, bushings, washers, or low-friction inserts (e.g., acetal, PTFE) may be disposed between adjacent tools 12 along the axle 16 to set deployment torque within about 5-40 Nm, for example. The axle 16 may be a removable screw-post to permit service or swaps of tools 12.

In certain embodiments, the housing 14 may include modular bays that accept sub-assemblies (“cartridges”) each carrying one or more tools 12. Cartridges having one or more tools 12 are retained by a fastener or detent so that a user can remove undesired tools and install different tools without special fixtures. The axle 16 may accept spacers to expand capacity or omit spacers to contract the form factor for pocket carry.

In the two-housing embodiment, a stop feature included in housing 14 and/or axle 16 may limit maximum opening to protect a tweezer or scissor linkage. Closing force applied to the housings is transmitted to opposed jaws through a pivot or flexure, enabling fine control for grooming tasks. A latch can hold the housings together in a closed state during carry, such as in a pocket, purse, or handbag.

In certain embodiments, an LED assembly may include a switch and a coin-cell or rechargeable cell within the housing 14. A USB memory device within housing 14 may be retractable; a portable charger embodiment may include a charging port and charge-management circuitry within housing 14.

In certain embodiments, housings 14 may be metal (stainless steel, aluminum), polymer (nylon, ABS), or composites, with exterior overmold or covers providing grip. Surfaces 18 can emulate sports-themed textures (e.g., stitched leather 20) or other novelty shapes while preserving ergonomic contours.

In certain embodiments, tools 12 such as toothpicks or writing instruments may be retained by interference fit, O-ring friction, magnetic capture, or a detented sleeve to prevent inadvertent ejection during carry.

Various modifications and alterations to the specific embodiments described above will be apparent to those skilled in the art. All such variations are included within the scope and spirit of the disclosure.

The preceding examples illustrate embodiments of the disclosure, but should not be viewed as limiting the scope of the disclosure.

Other embodiments and uses of the disclosure will be apparent to those skilled in the art from consideration of the specification and practice of the disclosure as disclosed herein. All references cited herein, including all publications, U.S. and foreign patents and patent applications, are specifically and entirely incorporated by reference. The term comprising, wherever used, is intended to include the terms consisting and consisting essentially of. Furthermore, the terms comprising, including, and containing are not intended to be limiting. It is intended that the specification and examples be considered exemplary only with the true scope and spirit of the disclosure indicated by the following claims.

1. A portable grooming multi-tool comprising:
an outer housing sized to fit in a user's hand;
an axle supported by the housing; a plurality of tools pivotally coupled to the axle and selectively movable between a stored position within the housing and a use position; and
a locking mechanism configured to releasably retain at least one of the tools in the stored position and/or in the use position;
wherein the plurality of tools includes at least one grooming tool selected from nail clippers, a nail file, scissors, tweezers, and a toothpick, and at least one miniature hand tool selected from a screwdriver and a bottle opener.

2. The grooming multi-tool of claim 1, wherein the housing comprises first and second housing portions arranged along a dominant length with opposing open sides sized to receive the tools when stored.

3. The grooming multi-tool of claim 1, wherein at least one tool includes a fingernail catch to facilitate extraction from the housing.

4. The grooming multi-tool of claim 1, wherein the locking mechanism comprises a spring-biased detent associated with the axle.

5. The grooming multi-tool of claim 1, further comprising a user-operable release coupled to the locking mechanism to at least partially present a selected tool for grasping.

6. The grooming multi-tool of claim 1, further comprising an electronic accessory disposed at least partially within the housing, the electronic accessory selected from an LED light, a USB memory device, charge-management circuitry, a rechargeable or primary cell, and a charging interface.

7. The grooming multi-tool of claim 1, further comprising an accessory bay formed in the housing and a removable accessory module received in the accessory bay.

8. The grooming multi-tool of claim 7, further comprising an electrical connector between the accessory module and the housing, the electrical connector comprising spring contacts, pogo pins, an edge connector, or a flexible circuit.

9. A grooming multi-tool comprising:
a pair of housings pinned together at a first end to define a hinge;
a pair of tweezers positioned between the housings and configured to be actuated by relative movement of the housings such that opening and closing the housings respectively opens and closes opposed jaws of the tweezers; and
a plurality of additional tools pivotally coupled to an axle carried by at least one of the housings and nestable within the housings when closed.

10. The grooming multi-tool of claim 9, wherein the tweezers are lockable in a deployed position via the axle or via the hinge pin.

11. The grooming multi-tool of claim 9, wherein at least one of the pair of housings defines an accessory bay and houses a removable accessory module.

12. The grooming multi-tool of claim 11, wherein the accessory module is accessible when the housings are opened and secured when the housings are closed.

13. The grooming multi-tool of claim 9, further comprising a port on at least one housing configured to operatively couple an external electronic accessory.

14. The grooming multi-tool of claim 9, wherein the plurality of additional tools comprises scissors or pliers, and the scissors or pliers are actuated by relative movement of the housings.

15. A method of using a portable grooming multi-tool having a housing, an axle supported by the housing, and a plurality of tools pivotally coupled to the axle, the method comprising:
actuating a release to overcome a lock retaining a selected tool in a stored position within the housing;
rotating the selected tool to a use position;
performing a task selected from a grooming operation and a miniature repair operation with the selected tool; and
returning the selected tool to the stored position.

16. The method of claim 15, wherein actuating the release comprises pressing a spring-loaded button that at least partially presents the selected tool for grasping.

17. The method of claim 15, wherein the multi-tool includes two housings pinned at one end and the selected tool is a pair of tweezers actuated by relative movement of the housings.

18. The method of claim 15, further comprising installing in the housing an accessory module carrying at least one electronic accessory and removing the accessory module to replace it with a different accessory module.

19. The method of claim 18, further comprising electrically coupling the accessory module to circuitry in the housing through a connector comprising spring contacts, pogo pins, an edge connector, or a flexible circuit.

20. The method of claim 15, further comprising energizing an electronic accessory during the performing step.
